(19) United States
(12) Patent Application Publication
(10) Pub. No.: US 2012/0330664 A1
(43) Pub. Date: Dec. 27, 2012

(54) METHOD AND APPARATUS FOR COMPUTING GAUSSIAN LIKELIHOODS

(76) Inventors: XIN LEI, SUNNYVALE, CA (US); JING ZHENG, SAN JOSE, CA (US)

(21) Appl. No.: 13/168,381

(22) Filed: Jun. 24, 2011

(51) Int. Cl. G10L 15/14

(52) U.S. Cl. 704/256.1; 704/E15.034

(57) ABSTRACT

The present invention relates to a method and apparatus for computing Gaussian likelihoods. One embodiment of a method for processing a speech sample includes generating a feature vector for each frame of the speech signal, evaluating the feature vector in accordance with a hierarchical Gaussian shortlist, and producing a hypothesis regarding a content of the speech signal, based on the evaluating.

### REFERENCE TO GOVERNMENT FUNDING

This application was made with Government support under contract no. NBCHD040058 awarded by the Department of the Interior. The Government has certain rights in this invention.

### FIELD OF THE INVENTION

The present invention relates generally to automatic speech recognition (ASR), and relates more particularly to Gaussian likelihood computation.

### BACKGROUND OF THE DISCLOSURE

Gaussian mixture models (GMMs) can be used in both the front end processing and the search stage of hidden Markov model (HMM)-based large vocabulary automatic speech recognition (ASR). During front end processing, GMMs are typically used in the computation of posterior vectors for generating feature space minimum phone error (fMPE) transforms that apply to feature vectors. During the search stage, the GMMs are typically used as acoustic models to model different sounds. During both of these stages, the use of a hierarchical Gaussian codebook can expedite Gaussian likelihood computation.

Gaussian likelihood computation is typically the most computationally intensive operation performed during HMM-based large vocabulary ASR. For instance, Gaussian likelihood computation often consumes thirty to seventy percent of the total recognition time. Thus, the speed with which an ASR system recognizes speech is directly tied to the speed with which it computes the Gaussian likelihoods.

### SUMMARY OF THE INVENTION

The present invention relates to a method and apparatus for computing Gaussian likelihoods. One embodiment of a method for processing a speech sample includes generating a feature vector for each frame of the speech signal, evaluating the feature vector in accordance with a hierarchical Gaussian shortlist, and producing a hypothesis regarding a content of the speech signal, based on the evaluating.

### BRIEF DESCRIPTION OF THE DRAWINGS

The teachings of the present invention can be readily understood by considering the following detailed description in conjunction with the accompanying drawings, in which:

FIG. 1 is a schematic diagram illustrating one embodiment of a system for performing automatic speech recognition, according to the present invention;

FIG. 2 is a schematic diagram illustrating an exemplary hierarchical Gaussian shortlist, according to the present invention;

FIG. 3 is a flow diagram illustrating one embodiment of a method for performing automatic speech recognition, according to the present invention; and

FIG. 4 is a high level block diagram of the present invention implemented using a general purpose computing device.

To facilitate understanding, identical reference numerals have been used, where possible, to designate identical elements that are common to the figures.

### DETAILED DESCRIPTION

The present invention relates to a method and apparatus for computing Gaussian likelihoods. Embodiments of the present invention use hierarchical Gaussian shortlists to improve the performance of standard vector quantization (VQ)-based Gaussian selection. First, all of the Gaussian components are merged into a number of indexing clusters (e.g., using bottom-up Gaussian clustering). Then, a shortlist is built for all of the clusters in each layer. This speeds the computation of Gaussian likelihoods, making it possible to achieve real-time ASR performance.

For a feature vector xₜ, the likelihood of an N-dimensional Gaussian distribution with a mean of μ and a covariance of Σ may be computed as:

$$p ( {x}_{t} \vert μ , \sum ) = \frac{1}{{( 2 π )}^{\frac{N}{2}} {\vert \sum \vert}^{\frac{1}{2}}} exp ( - \frac{1}{2} {( {x}_{t} - μ )}^{T} {\sum }^{- 1} ( {x}_{t} - μ ) ) \qquad ( EQN . 1 )$$

In most speech recognition systems, log likelihood is used for numerical stabilities, and diagonal covariance is used for data sparsity reasons. If the diagonal covariance is Σ=diag(σ₁², σ₂², . . . , σ_{N}²), then the log likelihood becomes:

$$log p ( {x}_{t} \vert μ , \sum ) = - \frac{1}{2} {\sum }_{i = 1}^{N} log ( 2 {πσ}_{i}^{2} ) - \frac{1}{2} {\sum }_{i = 1}^{N} \frac{{( {x}_{t} ( i ) - {μ}_{i} )}^{2}}{{σ}_{i}^{2}} \qquad ( EQN . 2 )$$

The first term is not related to the feature vector, and can be pre-computed before decoding. The second term can be further decomposed into a dot-product format, part of which can also be pre-computed.

Feature space minimum phone error (fMPE) is a training technique that adopts the same objective function as traditional minimum phone error (MPE) techniques for transforming feature vectors during training and decoding.

If xₜ denotes the original feature vector at time t, then the fMPE transformed feature vector is:

yₜ=xₜ+Mhₜ (EQN. 3)

Where hₜ is a high-dimensional posterior probability vector, and M is a matrix mapping hₜ onto a lower-dimensional feature space. The projection matrix M is trained to optimize the MPE criterion. The posterior probability vector hₜ is computed by first evaluating the likelihood of the original feature vector along a large set of Gaussians (e.g., all of the Gaussians in the acoustic model) with no priors. Then, for each frame, the posterior probabilities of the contextual frames are also computed and concatenated with the specified frame to form the final posterior probability vector hₜ. Although fMPE yields significant recognition accuracy, it is, as noted above, computationally expensive due to its naïve implementation, especially for real-time systems operating on portable devices.

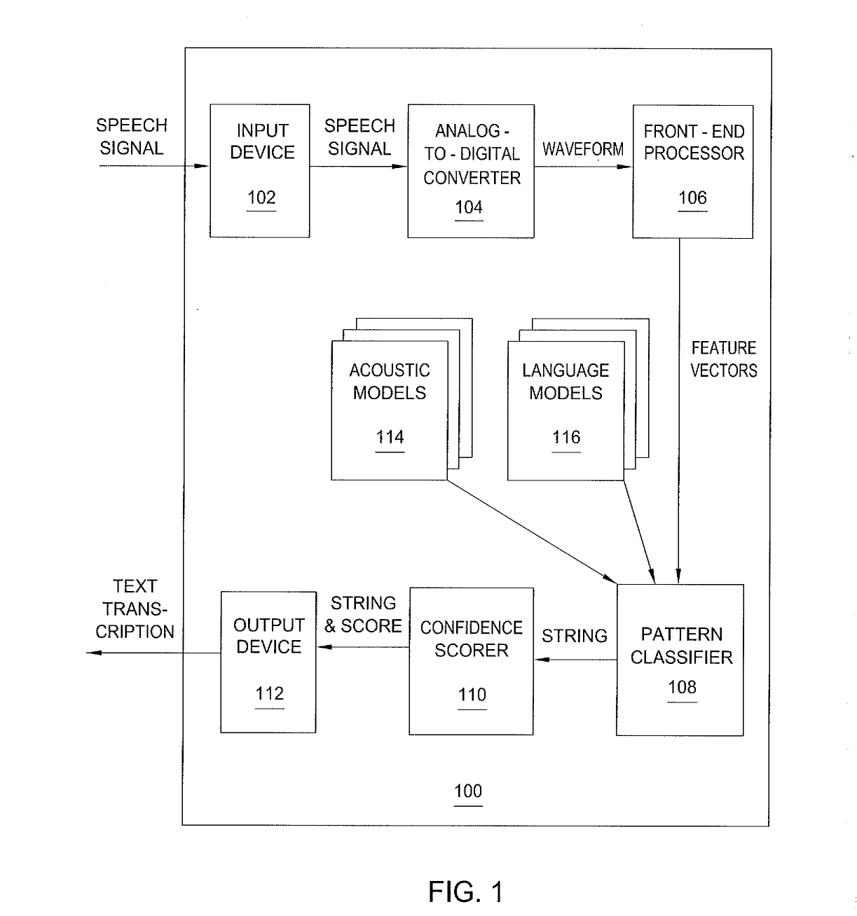

FIG. 1 is a schematic diagram illustrating one embodiment of a system 100 for performing automatic speech recognition (ASR), according to the present invention. The system 100 may be a subsystem of an ASR-based system or may be a stand-alone system. In particular, the system 100 is configured to process speech signals (e.g., user utterances) and to produce a processing result (e.g., a hypothesis) that reflects the speech signal, such as a textual transcription of the speech signal.

As illustrated, the system 100 comprises an input device 102, an analog-to-digital converter 104, a front-end processor 106, a pattern classifier 108, a confidence scorer 110, an output device 112, a plurality of acoustic models 114, and a plurality of language models 116. In alternative embodiments, one or more of these components may be optional. In further embodiments still, two or more of these components may be implemented as a single component.

The input device 102 receives input speech signals (e.g., user utterances). These input speech signals comprise data to be processed by the system 100. Thus, the input device 102 may include one or more of: a keyboard, a stylus, a mouse, a microphone, a camera, or a network interface (which allows the system 100 to receive input from remote devices).

The input device 102 is coupled to the analog-to-digital converter 104, which receives the input speech signal from the input device 102. The analog-to-digital converter 104 converts the analog form of the speech signal to a digital waveform. In an alternative embodiment, the speech signal may be digitized before it is provided to the input device 102; in this case, the analog-to-digital converter 104 is not necessary or may be bypassed during processing.

The analog-to-digital converter 104 is coupled to the front-end processor 106, which receives the waveforms from the analog-to-digital converter 104. The front-end processor 106 processes the waveform in accordance with one or more feature analysis techniques (e.g., spectral analysis). In addition, the front-end processor may perform one or more pre-processing techniques (e.g., noise reduction, endpointing, etc.) prior to the feature analysis. The result of this processing is a set of feature vectors that are computed on a frame-by-frame basis for each frame of the waveform. The front-end processor 106 is coupled to the pattern classifier 108 and delivers the feature vectors to the pattern classifier 108.

The pattern classifier 108 decodes the feature vectors into a string of words that is most likely to correspond to the input speech signal. To this end, the pattern classifier 108 performs decoding and/or searching in accordance with the feature vectors. In one embodiment, and at each frame, the pattern classifier 108 evaluates the corresponding feature vector for at least a subset of Gaussians in a Gaussian codebook (e.g., in accordance with fMPE). In one embodiment, the feature vectors are evaluated using a hierarchical Gaussian shortlist that comprises a subset of the Gaussians in the Gaussian codebook.

In one embodiment, the pattern classifier 108 also performs a search (e.g., a Viterbi search) guided by the acoustic models 114 and the language models 116. This search produces an acoustic model score and a language model score for each hypothesis or proposed string that may correspond to the waveform. The search may also may use of a hierarchical Gaussian shortlist.

The plurality of acoustic models 114 comprises statistical representations of the sounds that make up words. In one embodiment, at least some of the acoustic models comprise finite state networks, where each state comprises a Gaussian mixture model (GMM) the models the statistical representation for an associated sound. In a further embodiment, the finite state networks are weighted.

The plurality of language models 116 comprises probabilities (e.g., in the form of distributions) of sequences of words (e.g., N-grams). Different language models may be associated with different languages, contexts, and applications. In one embodiment, at least some of the language models 116 are grammar files containing predefined combinations of words.

The confidence scorer 110 is coupled to the pattern classifier 108 and receives the string from the pattern classifier 108. The confidence score 110 assigns a confidence score to each word in the string before delivering the string and the confidence scores to the output device 112.

The output device 112 is coupled to the confidence scorer 110 and receives the string and confidence scores from the confidence scorer 110. The output device 112 delivers the system output (e.g., textual transcriptions of the input speech signal) to a user or to another device or system. Thus, in one embodiment, the output device 112 comprises one or more of the following: a display, a speaker, a haptic device, or a network interface (which allows the system 100 to send outputs to a remote device).

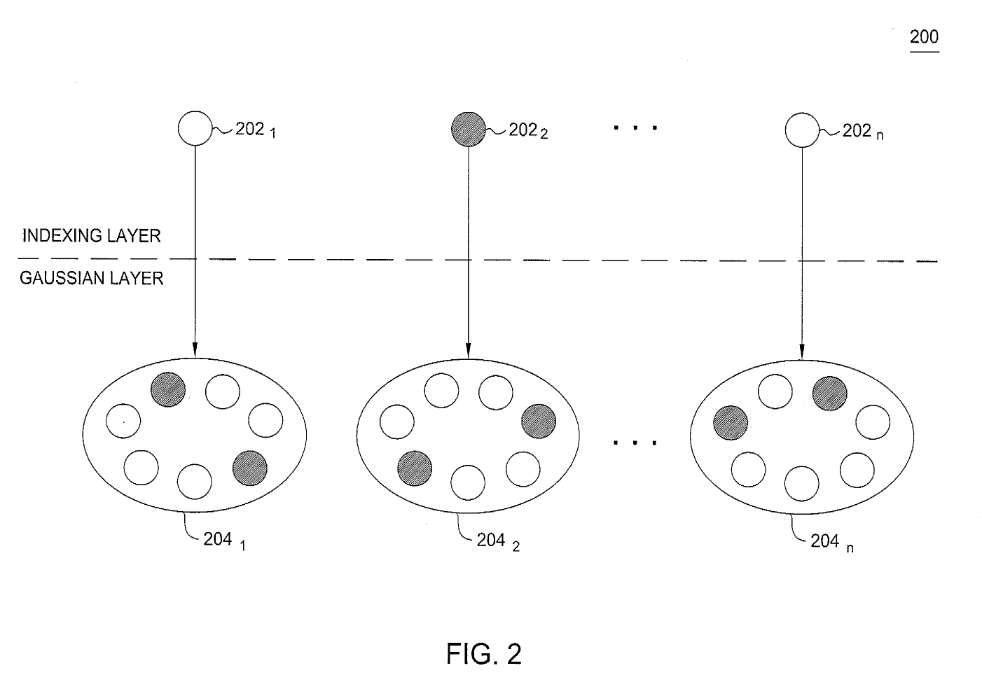

As discussed above, the system 100 makes use of a set of hierarchical Gaussian shortlists. FIG. 2 is a schematic diagram illustrating an exemplary hierarchical Gaussian shortlist 200, according to the present invention. Specifically, FIG. 2 illustrates how the hierarchical Gaussian shortlist 200 applies to a hierarchical Gaussian codebook. The hierarchical Gaussian shortlist 200 is hierarchical in that it organizes the Gaussians into a tree-like structure that contains at least two layers. For example, the exemplary hierarchical Gaussian shortlist 200 illustrated in FIG. 2 comprises two layers: an indexing layer and a Gaussian layer.

The indexing layer comprises a plurality of indexing Gaussians 202₁-202ₙ (hereinafter collectively referred to as “indexing Gaussians 202”). Each indexing Gaussian 202 corresponds to a cluster 204₁-204ₙ (hereinafter collectively referred to as “clusters 204”) in the Gaussian layer. Thus, each indexing Gaussian 202 may be considered a parent of its corresponding cluster 204.

In one embodiment, the acoustic space is divided into a number of partitions, and a hierarchical Gaussian shortlist such as the hierarchical Gaussian shortlist 200 is built for each partition. The hierarchical Gaussian shortlist 200 for a given partition specifies the subset of Gaussians that are expected to have high likelihood values in the given partition.

In one embodiment, the acoustic space is divided into the partitions using vector quanitization (VQ); thus, the partitions may also be referred to as VQ regions. VQ codebooks are then organized as a tree to quickly locate the VQ region within which a given feature vector falls. Next, one list of Gaussians is created for each combination (v, s) of VQ region v and tied acoustic state s. In one embodiment, the list is created empirically by considering a sufficiently large amount of speech data. For each acoustic observation, every Gaussian is evaluated. The Gaussians whose likelihoods are within a predefined threshold of the most likely Gaussian are then added to the list for the combination (v, s) of VQ region and acoustic state. In one embodiment, a minimum size is enforced for each shortlist in order to ensure that there are no empty shortlists.

The hierarchical Gaussian shortlist 200 is not directly plotted. Rather, as illustrated in FIG. 2, Gaussians that are selected by the hierarchical Gaussian shortlist are identified in some way (e.g., selected Gaussians are marked as gray in FIG. 2). Thus, the objective of the hierarchical Gaussian shortlist 200 is to efficiently find the most likely Gaussians in the Gaussian codebook and therefore avoid unnecessary computation.

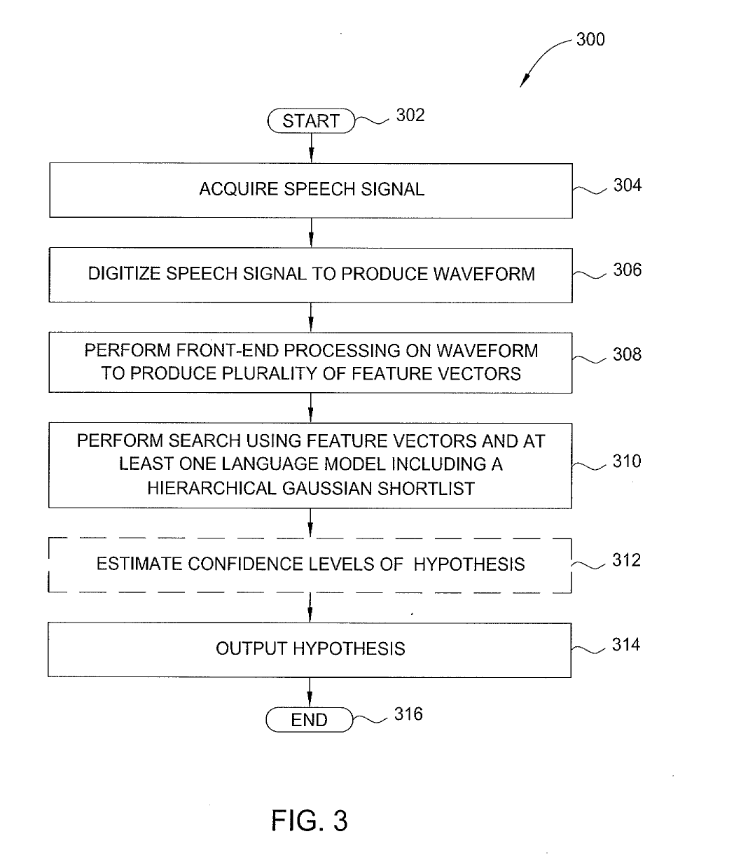

FIG. 3 is a flow diagram illustrating one embodiment of a method 300 for performing automatic speech recognition, according to the present invention. The method 300 may be implemented, for example, by the system 100 illustrated in FIG. 1. As such, reference is made in the discussion of FIG. 3 to various elements of FIG. 1. It will be appreciated, however, that the method 300 is not limited to execution within a system configured exactly as illustrated in FIG. 1 and, may, in fact, execute within systems having alternative configurations.

The method 300 is initialized in step 302 and proceeds to step 304, where the input device 102 acquires a speech signal (e.g., a user utterance). In optional step 306 (illustrated in phantom), the analog-to-digital converter 104 digitizes the speech signal, if necessary, to generate a waveform. In instances where the speech signal is acquired in digital form, digitization by the analog-to-digital converter 104 will not be necessary.

In step 308, the front-end processor 106 processes the frames of the waveform to produce a plurality of feature vectors. As discussed above, the feature vectors are produced on a frame-by-frame basis.

In step 310, the pattern classifier 108 performs a search (e.g., a Viterbi search) in accordance with the feature vectors and with the language models 116. The ultimate result of the search comprises one or more hypotheses (e.g., strings of words) representing the possible content of the speech signal. Each hypothesis is associated with a likelihood that it is the correct hypothesis. In one embodiment, the likelihood is based on a language model score and an acoustic model score.

In one embodiment, the acoustic model score is calculated using hierarchical Gaussian shortlists, as discussed above. In accordance with this embodiment, some states of a given acoustic model (finite state network) are active, and some states are not active. Each feature vector for each frame of the waveform is evaluated against only the active states of the acoustic model.

Specifically, the first step in generating the acoustic model score is to identify, in accordance with a given feature vector, the VQ region most closely associated with the corresponding frame from which the feature vector came. The identified VQ region is then used to guide evaluation of the Gaussians in the Gaussian codebook.

Referring again to FIG. 2, all of the Gaussians in the Gaussian codebook are clustered into n clusters 204. In one embodiment, the clustering criterion is an entropy-based measure. For a given feature vector at a given frame of the waveform, the feature vector is evaluated against only a shortlist of indexing Gaussians 202 (i.e., as opposed to against all of the indexing Gaussians 202). This may be referred to as an “indexing layer shortlist.” The indexing layer shortlist comprises the most probable indexing Gaussians 202 for the VQ region associated with the given feature vector. Then, the x indexing Gaussians 202 having the highest likelihoods based on the evaluation are selected for further evaluation.

The further evaluation again comprises evaluation against shortlists. Specifically, each cluster 204 associated with each of the x indexing Gaussians 202 is arranged as a shortlist. This may be referred to as a “Gaussian layer shortlist.” The Gaussian layer shortlist comprises the most probable Gaussians within the associated cluster 204 for the VQ region associated with the given feature vector. In one embodiment, a Gaussian layer shortlist is built for each combination of VQ region and cluster 204. In each cluster 204 that is selected for further evaluation, only the Gaussians in the cluster's Gaussian layer shortlist are evaluated against the feature vector. In this way, Gaussian likelihood computation is limited to a relatively small number of Gaussians in both the indexing layer and the lower Gaussian layer.

When likelihoods have been generated for each of the hypotheses, the method 300 proceeds to optional step 312, where the confidence scorer 110 estimates the confidence levels of the hypotheses, and optionally corrects words in the hypotheses based on word-level posterior probabilities. The output device 112 then outputs at least one of the hypotheses (e.g., as a text transcription of the speech signal) in step 314.

The method 300 terminates in step 316.

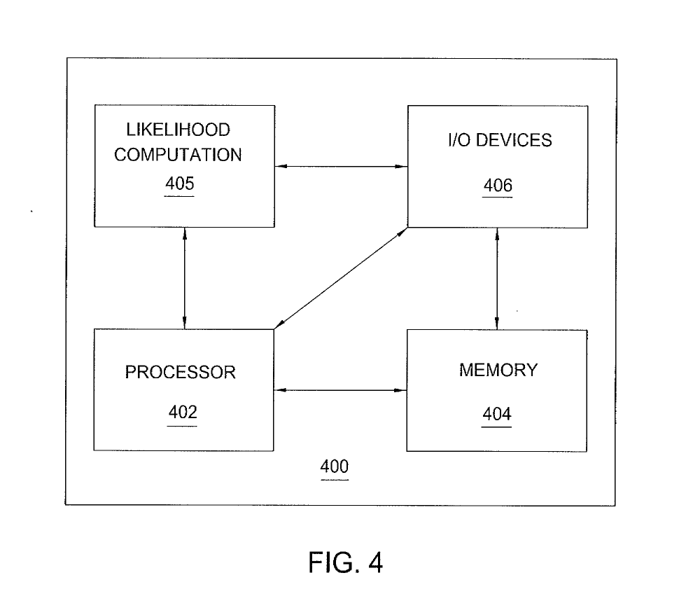

FIG. 4 is a high level block diagram of the present invention implemented using a general purpose computing device 400. It should be understood that embodiments of the invention can be implemented as a physical device or subsystem that is coupled to a processor through a communication channel. Therefore, in one embodiment, a general purpose computing device 400 comprises a processor 402, a memory 404, a likelihood computation module 405, and various input/output (I/O) devices 406 such as a display, a keyboard, a mouse, a modem, a microphone, speakers, a touch screen, and the like. In one embodiment, at least one I/O device is a storage device (e.g., a disk drive, an optical disk drive, a floppy disk drive).

Alternatively, embodiments of the present invention (e.g., error correction module likelihood computation 405) can be represented by one or more software applications (or even a combination of software and hardware, e.g., using Application Specific Integrated Circuits (ASIC)), where the software is loaded from a storage medium (e.g., I/O devices 406) and operated by the processor 402 in the memory 404 of the general purpose computing device 400. Thus, in one embodiment, the likelihood computation 405 for computing Gaussian likelihoods described herein with reference to the preceding Figures can be stored on a non-transitory computer readable medium (e.g., RAM, magnetic or optical drive or diskette, and the like).

It should be noted that although not explicitly specified, one or more steps of the methods described herein may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in the accompanying Figures that recite a determining operation or involve a decision, do not necessarily require that both branches of the determining operation be practiced. In other words, one of the branches of the determining operation can be deemed as an optional step.

Although various embodiments which incorporate the teachings of the present invention have been shown and described in detail herein, those skilled in the art can readily devise many other varied embodiments that still incorporate these teachings.

What is claimed is:

1. A method for processing a speech signal, the method comprising:
generating a feature vector for each frame of the speech signal;
evaluating the feature vector in accordance with a hierarchical Gaussian shortlist; and
producing a hypothesis regarding a content of the speech signal, based on the evaluating.

2. The method of claim 1, wherein the hierarchical Gaussian shortlist comprises a set of Gaussians, the set comprising a subset of a Gaussian codebook.

3. The method of claim 2, wherein the hierarchical Gaussian shortlist is associated with a partition of an acoustic space.

4. The method of claim 3, wherein the subset comprises Gaussians in the Gaussian codebook that have high likelihood values within the partition.

5. The method of claim 3, wherein the partition is defined using vector quantization.

6. The method of claim 3, wherein the partition is associated with the feature vector.

7. The method of claim 2, wherein the hierarchical Gaussian shortlist comprises a plurality of layers arranged in a tree-like structure, each of the plurality of layers containing a portion of the set of Gaussians.

8. The method of claim 7, wherein a highest layer in the plurality of layers comprises a plurality of individual indexing Gaussians.

9. The method of claim 8, wherein each of the plurality of individual indexing Gaussians corresponds to a cluster in a lower one of the plurality of layers.

10. The method of claim 9, wherein the cluster comprises a subset of the set of Gaussians.

11. The method of claim 10, wherein the evaluating comprises:
identifying an acoustic space partition within which the feature vector falls;
and assessing the feature vector against only those Gaussians in the Gaussian codebook falling within the hierarchical Gaussian shortlist.

12. The method of claim 11, wherein the assessing comprises:
generating a first set of likelihoods for the feature vector based only on a subset of the plurality of individual indexing Gaussians having highest probabilities associated with the acoustic space partition;
identifying a subset of the plurality of individual indexing Gaussians having highest likelihoods among the first set of likelihoods; and
generating a second set of likelihoods for the feature vector based only on a cluster corresponding to an individual indexing Gaussian within the subset of the plurality of individual indexing Gaussians.

13. The method of claim 12, wherein the generating the second set of likelihoods comprises:
evaluating the feature vector against only a portion of the subset of the set of Gaussians having highest probabilities associated with the acoustic space partition.

14. A computer readable storage device containing an executable program for processing a speech signal, where the program performs steps comprising:
generating a feature vector for each frame of the speech signal;
evaluating the feature vector in accordance with a hierarchical Gaussian shortlist; and
producing a hypothesis regarding a content of the speech signal, based on the evaluating.

15. The computer readable storage device of claim 14, wherein the hierarchical Gaussian shortlist comprises a set of Gaussians, the set comprising a subset of a Gaussian codebook.

16. The computer readable storage device of claim 15, wherein the hierarchical Gaussian shortlist is associated with a partition of an acoustic space.

17. The computer readable storage device of claim 16, wherein the subset comprises Gaussians in the Gaussian codebook that have high likelihood values within the partition.

18. The computer readable storage device of claim 16, wherein the partition is defined using vector quantization.

19. The computer readable storage device of claim 16, wherein the partition is associated with the feature vector.

20. A system for processing a speech signal, the system comprising:
a processor for generating a feature vector for each frame of the speech signal;
a classifier for evaluating the feature vector in accordance with a hierarchical Gaussian shortlist; and
a scorer for producing a hypothesis regarding a content of the speech signal, based on the evaluating.
